(19) United States
(12) Patent Application Publication
(10) Pub. No.: US 2012/0213899 A1
(43) Pub. Date: Aug. 23, 2012

(54) PROCESS FOR PRODUCING FROZEN CONFECTIONERY PRODUCTS

(76) Inventors: Alexander Aldred, Sharnbrook (GB); Dorothy Margaret Chamberlain, Sharnbrook (GB)

(21) Appl. No.: 13/503,411

(22) PCT Filed: Sep. 23, 2010
(86) PCT No.: PCT/EP2010/064085

§ 371 Date: May 7, 2012

(30) Foreign Application Priority Data
Oct. 29, 2009 (EP) 09174451.6

(51) Int. Cl. A23G 9/42

(52) U.S. Cl. 426/327

(57) ABSTRACT

A process for producing a frozen confectionery product comprising a frozen composition which contains inclusions in the form of frozen particles is provided, the process comprising: preparing a mix of ingredients having a total solids content of from 5 to 25% and containing from 0.2 to 2.0 wt % of one or more stabilisers; optionally pasteurising and/or homogenising and/or ageing the mix; freezing the mix to form frozen particles in a fragmented ice maker comprising a refrigerated barrel and a screw auger; and dosing the frozen particles into the frozen composition.

### TECHNICAL FIELD OF THE INVENTION

The present invention relates to a process for producing frozen confectionery products which contain inclusions, in particular it relates to inclusions which have a low solids content.

### BACKGROUND TO THE INVENTION

It is well-known to incorporate inclusions, such as pieces of chocolate, fruit, nut, biscuit, toffee etc. into frozen confections such as ice cream. Inclusions provide consumer appeal because of the taste and texture contrast they provide. However, inclusions such as chocolate and toffee pieces typically contain high amounts of sugar and/or fat. Fruit pieces are normally infused with large amounts of sugar before they can be used as inclusions in frozen confections as otherwise they would be too hard and not have the desired (e.g. chewy) texture. Consumers are increasingly looking for frozen confections that are healthier. However, reducing the amount of sugar/fat has an undesirable effect on the texture of the inclusions, for example fruit pieces become very hard and icy.

GB 2 008 382 and GB 1 369 199 disclose frozen confections which contain fruit-flavoured gel beadlets. The gel beadlets have a texture resembling that of natural fruit. The beadlets must contain sufficient freezing point depressants (typically sugars) so that they are in a compressible gel state and are biteable at the temperatures of frozen confections. A particular process and particular gel-forming stabilisers are required in order to produce them: droplets of a solution of the fruit material containing sodium alginate are dropped into a solution containing calcium ions. The calcium ions combine with the alginate to form the gel.

Therefore there remains a need for frozen confections with inclusions which contain reduced amounts of sugar and/or fat but which have textures similar to those of conventional inclusions and which can be produced in a simple manner.

### BRIEF DESCRIPTION OF THE INVENTION

We have now devised a simple process for producing inclusions with low sugar/fat contents in the form of frozen particles. The process does not require a gel to be formed before freezing. The frozen particle inclusions have the desired chewy texture, provided that they contain a minimum amount of stabiliser. Accordingly, in a first aspect, the present invention provides a process for producing a frozen confectionery product comprising a frozen composition which contains inclusions in the form of frozen particles, the process comprising:
(i) preparing a mix of ingredients having a total solids content of from 5 to 25% and containing from 0.2 to 2.0 wt % of one or more stabilisers;
(ii) optionally pasteurising and/or homogenising and/or ageing the mix;
(iii) freezing the mix in a fragmented ice maker comprising a refrigerated barrel and a screw auger to form the frozen particles; and
(iv) dosing the frozen particles into the frozen composition.

Preferably the stabilisers do not form a gel prior to freezing.

Preferably the size of the frozen particles is mechanically reduced before, during or after step (iv).

Preferably the stabiliser comprises locust bean gum, guar gum, tara gum, iota carrageenan, low methoxy pectin, alginate and mixtures thereof. More preferably the stabiliser consists essentially of locust bean gum.

Preferably the frozen particles comprise from 0.3 to 1.0 wt % of stabiliser.

Preferably the frozen particles have a total solids content of from 10 to 20 wt %.

Preferably the frozen particles in the frozen composition are from 1 to 20 mm in diameter, more preferably 2 to 10 mm.

Preferably the amount of frozen particles is from 2 to 30% by weight of the frozen confectionery product.

Preferably the frozen particles are chocolate-flavoured.

Preferably the frozen composition is ice cream, water ice, milk ice, sorbet, sherbet or frozen yoghurt.

### DETAILED DESCRIPTION OF THE INVENTION

Unless defined otherwise, all technical and scientific terms used herein have the same meaning as commonly understood by one of ordinary skill in the art (e.g. in frozen confectionery manufacture). Definitions and descriptions of various terms and techniques used in frozen confectionery manufacture are found in Ice Cream, 6^{th} Edition, R. T. Marshall, H. D. Goff and R. W. Hartel (2003), Kluwer Academic/Plenum Publishers. All percentages, unless otherwise stated, refer to the percentage by weight, with the exception of percentages cited in relation to the overrun.

The term “frozen composition” means a sweet-tasting fabricated foodstuff in the frozen state (i.e. under conditions wherein the temperature of the foodstuff is less than 0° C., and preferably under conditions wherein the foodstuff comprises significant amounts of ice). Frozen compositions include ice cream, water ice, milk ice, sorbet, sherbet, frozen yoghurt and the like. Frozen compositions may be aerated or unaerated. Aerated frozen compositions have an overrun of more than 20%, preferably more than 50%, more preferably more than 75%. Preferably the frozen composition has an overrun of less than 200%, more preferably less than 150%, most preferably less than 120%. Overrun is defined by the equation below and is measured at atmospheric pressure

$$overrun \% = \frac{density of mix - density of frozen confection}{density of frozen confection} \times 100$$

The frozen composition may be manufactured by any suitable process, typically by preparing a mix of ingredients; then pasteurising and optionally homogenising the mix; and then freezing and optionally aerating the mix to produce the frozen composition.

The frozen particles mostly consist of ice and have a total solids content of at most 25%, preferably at most 20%, more preferably at most 19% total solids. The lower the total solids content (and hence sugar content), the more attractive is the product to health conscious consumers. However, the frozen particles have a total solids content of at least 5%, preferably at least 10%, more preferably at least 15%, since if the total solids content is too low, the texture of the frozen particle becomes hard and icy. The total solids content of a frozen particle is its dry weight, i.e. the sum of the weights of all the ingredients other than water, expressed as a percentage of the total weight. It is measured by the oven drying method as described in Ice Cream, 6th Edition, Marshall et al. (2003) p 296.

The frozen particles contain at least 0.2 wt %, preferably at least 0.25wt %, more preferably at least 0.3 wt % of a stabiliser; and at most 2%, preferably at most 1%, more preferably at most 0.75% The presence of stabiliser at these relatively high levels results in a soft and chewy texture.

Suitable stabilisers include plant extrudates such as gum arabic, gum ghatti, gum karaya, gum tragacanth; seed gums such as locust bean gum, guar gum, tara gum, psyyllium seed gum, quince seed gum or tamarind seed gum; konjac mannan; seaweed extracts such as alginates, carrageenans (e.g. iota carrageenan and kappa carrageenan) or furcelleran; pectins such as low methoxyl or high methoxyl-type pectins; cellulose derivatives such as sodium carboxymethyl cellulose, microcrystalline cellulose, methyl and methylethyl celluloses, or hydroxylpropyl and hydroxypropylmethyl celluloses; modified starches; and microbial gums such as dextran, xanthan or β-1,3-glucan. Mixtures of stabilisers may be used. It is believed that the presence of a relatively high amount of stabilisers in the frozen particles modifies their texture, resulting in chewy inclusions. Preferably the stabiliser comprises locust bean gum, guar gum, tara gum, iota carrageenan, low methoxy pectin or alginate. Most preferably the stabiliser is locust bean gum. We have found that locust bean gum gives particularly chewy inclusions. Locust bean gum has the ability to cryogel, i.e. to form a gel during freezing. Without wishing to be limited by theory, it is believed that the gel forms within the frozen particles and thereby modifies their texture. This gives even better results than stabilisers which are thickeners, but do not gel (such as guar gum). It also gives better results than stabilisers which gel before freezing (e.g. alginate which gels in the presence of calcium ions), since such gels can be damaged or disrupted during freezing.

In addition to the stabiliser, the other solids present in the frozen particles are typically mostly sugars. Optionally, ingredients such as proteins (e.g. from milk), flavours (e.g. cocoa powder for chocolate-flavoured inclusions, fruit material such as juice or puree), colours, fat, emulsifiers etc. may be included. The sugars provide most of the freezing point depression, and hence determine the ice content of the frozen particle, which in turn affects the texture. When the solids content is essentially made up of the sugars, with only small amounts of other ingredients, solids contents at the lower end of the range (e.g. about 5 to 10%) are preferably used. When the non-sugar ingredients make up a larger proportion of the total solids, it is preferred that the frozen particles have a solids content toward the higher end of the range, e.g. at least about 15%, since the non-sugar ingredients have little effect on the ice content and the frozen particles could otherwise be quite icy.

In a preferred embodiment, the frozen particles are chocolate flavoured, so that they contain at least 1 wt %, preferably at least 2 wt % cocoa solids, e.g. in the form of cocoa powder.

The frozen particles are manufactured by a simple process which does not require that a gel is formed before freezing. First, a mix is prepared by blending the ingredients (sugars, stabilisers, milk protein, fats, colours and flavours etc.) into hot water (generally >60° C.). The mix may then be homogenised, pasteurised (>80° C.) and then cooled to 10° C. or below and held for a period (typically >4 hours) in an ageing vessel. Heat sensitive ingredients, such as fruit, flavours or colours, can be added directly into the cooled mix at this point. The frozen particles are produced in a continuous process by using a fragmented ice maker (such as the Ziegra Ice machine ZNE 2000, ZIEGRA-Eismaschinen GmbH, Isernhagen, Germany). A fragmented ice maker is described in U.S. Pat. No. 4,569,209. The mix is pumped into the base of the ice machine and drawn through its barrel by a rotating screw auger. The barrel is cooled which freezes the mix into an ice slurry as it rises through the barrel. By the time the slurry reaches the top of the barrel, it has formed solid pieces, typically ˜1 cm in diameter, which exit the barrel through its open upper end. The temperature of these pieces is generally between −0.5 and −3° C. depending on the composition of the mix. The balance of the cooling and rotational speed is important. If there is not enough cooling (e.g. the barrel temperature is too high, or the rotational speed is too fast so that the mix has a short residence time inside the barrel), slushy, soft frozen pieces are formed, which are difficult to handle in subsequent processing. Alternatively if there is too much cooling (barrel temperature too low and/or rotation rate too slow, hence residence time too high) the mix in the barrel will freeze completely, so that it cannot come out of the open end, and mechanical damage may be caused to the machinery. The ice maker operates well with mixes that have relatively low solids contents (i.e. less than 25%), such as single strength fruit puree, fruit juice or milk, and also water ice or milk ice mixes.

The frozen particles may be combined with the frozen composition by means of an inclusion feeder which doses the frozen particles into the frozen composition e.g. with a rotating paddle element. The frozen composition should be sufficiently soft/flowable to blend in the frozen particles, i.e. it will typically be partially frozen at a temperature of −2° C. or below, typically around −5° C. The frozen particles are preferably at a temperature of about −0.5° C. or below when combined with the frozen composition. Preferably the frozen particles are at a temperature of no lower than −10° C., so that they do not cool the frozen composition down so much that it becomes stiff and difficult to process further, e.g. to extrude. After dosing, the frozen particles are distributed into the frozen composition, i.e. they are inclusions.

Preferably the frozen particles in the frozen confectionery product are at least 1 mm in diameter, more preferably at least 2 mm. Preferably the frozen particles are less than 20 mm in diameter, more preferably less than 10 mm, since inclusions of this size are generally preferred by consumers. It is possible to produce frozen particles which are larger than the required size of inclusion, and then subsequently reduce their size, e.g. by using a mechanical crushing device to achieve the desired size of inclusions. A size reduction step provides a convenient method of ensuring that the inclusions have a size within the preferred ranges. This size reduction step can be made before combining the frozen particles with the other ingredients of the frozen confection, or alternatively afterwards by using an in-line crushing devices, e.g. by passing the mixture through a constriction of the required size. A suitable size-reduction device (a crushing pump) which allows for in-line reduction of particle size is described in WO 2006/007922.

The amount of frozen particles is preferably at least 2% by weight of the combined amount of frozen particles and frozen composition, more preferably at least 5 wt %. Preferably the amount of frozen particles is less than 30 wt %, more preferably less than 20 wt %.

After dosing the frozen particles into the frozen composition, the product may be further frozen (hardened), subjected to further process steps (e.g. dipping/coating), packaged and stored. The frozen confectionery products are typically single serving products e.g. 50-200 mL, preferably 70-150 mL in size. They may consist of a receptacle, which may be edible (e.g. a wafer or chocolate cone) or inedible (e.g. a tub). Alternatively, they may be stick products, for example produced by extruding frozen composition containing frozen particles into moulds.

### EXAMPLES

The invention will now be further described with reference to the following examples, which are illustrative only and non-limiting.

### Examples 1-7

Mixes were prepared according to the formulations in Table 1, as follows. The ingredients were combined in an agitated heated mix tank and subjected to high shear mixing at a temperature of 65° C. for 2 minutes. The resulting mix was then passed through an homogeniser at 150 bar and 70° C., pasteurised at 83° C. for 20 s and then rapidly cooled to 4° C. using a plate heat exchanger. The mixes were then held at +2 to +5° C. in a stirred holding tank until required for freezing.

TABLE 1

| | Example | | | | | | |
|---|---|---|---|---|---|---|---|
| Ingredient (wt %) | 1 | 2 | 3 | 4 | 5 | 6 | 7 |
| Sucrose | 6.0 | 6.0 | 6.0 | 6.0 | 6.0 | 6.0 | 6.0 |
| 63 DE corn syrup* | 2.8 | 2.8 | 2.8 | 2.8 | 2.8 | 2.8 | 2.8 |
| Skim milk powder | 7.0 | 7.0 | 7.0 | 7.0 | 7.0 | 7.0 | 7.0 |
| Cocoa Powder | 2.8 | 2.8 | 2.8 | 2.8 | 2.8 | 2.8 | 2.8 |
| LBG | 0.15 | 0.25 | 0.35 | | | | |
| Guar | | | | 0.15 | 0.25 | 0.35 | |
| Iota-carrageenan | | | | | | | 0.35 |
| Water | To 100 | To 100 | To 100 | To 100 | To 100 | To 100 | To 100 |
| Total solids | 18.1 | 18.2 | 18.3 | 18.1 | 18.2 | 18.3 | 18.3 |

*78% solids

The chilled mixes were pumped from the holding tank into an ice particle maker. This is a modified commercial ice machine (Ziegra Eismachinen GmbH) with a vertically mounted screw auger encased in a bronze barrel that is cooled using Freon 4404 refrigeration. The applied cooling can be controlled as well as the speed of rotation of the auger which affects the residence time of the slurry in the barrel. The compressor speed (40 Hz) controlling the refrigeration to the exterior of the barrel (temperature −30° C.) and the rotational speed of the auger (23 rpm) inside the barrel were balanced to freeze the mix into particles of typical size 10×10×10 to 20 mm at a throughput of 80-100 kg/hr. The particles left the ice particle maker at a temperature of about −2° C. and were introduced into a vane-style feeder (Hoyer FF4000) which mixed them into standard ice cream mixes. Subsequently these pieces were mechanically reduced to produce 4-10 mm sized particles using a size-reduction device as described in WO 2006/007922.

Some particles from each example were collected separately for tasting. Examples 1 and 4 (containing a conventional amount of stabiliser) were found to have an icy texture, whereas examples 2, 3, 5, 6 and 7, which contained at least 0.25% stabiliser (LBG, guar or iota carrageenan) were chewy. Examples 2 and 3, containing LBG, were judged to be the chewiest.

### Examples 8-11

Mixes were prepared according to the formulations in Table 2 and processed as described in example 1.

TABLE 2

| | Example | | | |
|---|---|---|---|---|
| Ingredient (wt %) | 8 | 9 | 10 | 11 |
| Sucrose | 4.8 | 3.0 | 6.0 | 5.0 |
| 63 DE Corn Syrup (78% solids) | 2.25 | 1.4 | 6.0 | |
| Fructose | | | | 3.0 |
| Skim milk powder | 5.6 | 3.5 | | 3.0 |
| Coconut oil | | | | 1.25 |
| Cocoa Powder | 2.25 | 1.4 | | |
| Strawberry Juice Concentrate 65 | | | 3.5 | |
| Brix | | | | |
| Emulsifier | | | | 0.1 |
| Flavour and colour | | | 0.4 | 0.3 |
| LBG | 0.35 | 0.35 | 0.3 | 0.3 |
| Water | To 100 | To 100 | To 100 | To 100 |
| Total solids | 14.8 | 9.3 | 13.6 | 12.5 |

Examples 8, 10 and 11 were all chewy. Example 9 which had the lowest solids content was less chewy and had some iciness.

### Examples 12-14

Mixes were prepared according to the formulations in Table 3 and processed as described in example 1.

TABLE 3

Example

| Ingredient (wt %) | 12 | 13 | 14 |
|---|---|---|---|
| Sucrose | 5.5 | 5.5 | 5.0 |
| 63 DE Corn Syrup (78% solids) | 2.8 | 2.8 | |
| Fructose | 1.3 | 1.3 | 3.0 |
| Skim milk powder | 7.0 | 7.0 | 3.0 |
| Butterfat | 1.55 | 1.55 | 1.25 |
| Cocoa Powder | 4.5 | 4.5 | |
| Emulsifier | | | 0.1 |
| Colour | | | 0.2 |
| LBG | 0.25 | 0.35 | 0.3 |
| Water | To 100 | To 100 | To 100 |
| Total solids | 18.2 | 18.3 | 12.5 |

Examples 12, 13 and 14 were all chewy. The frozen particles of examples 12 and 13 were mixed into a standard milk ice, and those of example 14 were mixed into a standard vanilla ice cream to produce frozen confectionery products containing inclusions. When the products were consumed, the frozen particles retained their chewy texture.

The examples show that frozen particle inclusions with low solids contents, in particular low sugar and fat contents, can be prepared in a simple, continuous process. The presence of at least 0.2% stabiliser ensures that the frozen particle inclusions have the desired chewy texture.

The various features of the embodiments of the present invention referred to in individual sections above apply, as appropriate, to other sections mutatis mutandis. Consequently features specified in one section may be combined with features specified in other sections as appropriate.

1. A process for producing a frozen confectionery product comprising a frozen composition which contains inclusions in the form of frozen particles, the process comprising:
(i) preparing a mix of ingredients having a total solids content of from 5 to 25% and containing from 0.2 to 2.0 wt % of one or more stabilisers;
(ii) optionally pasteurising and/or homogenising and/or ageing the mix;
(iii) freezing the mix to form frozen particles in a fragmented ice maker comprising a refrigerated barrel and a screw auger; and
(iv) dosing the frozen particles into the frozen composition.

2. A process according to claim 1 wherein the stabilisers do not form a gel prior to freezing.

3. A process according to claim 1 wherein the size of the frozen particles is mechanically reduced before, during or after step (iv).

4. A process according to claim 1 wherein the stabiliser comprises locust bean gum, guar gum, tara gum, iota carrageenan, low methoxy pectin, alginate and mixtures thereof.

5. A process according to claim 1 wherein the stabiliser comprises locust bean gum.

6. A process according to claim 1 wherein the stabiliser consists essentially of locust bean gum.

7. A process according to claim 1 wherein the frozen particles comprise from 0.3 to 1.0 wt % of stabiliser.

8. A process according to claim 1 wherein the frozen particles have a total solids content of from 10 to 20 wt %.

9. A process according to claim 1 wherein the frozen particles in the frozen confectionery product are from 1 to 20 mm in diameter.

10. A process according to claim 1 wherein the amount of frozen particles is from 2 to 30% by weight of the frozen confectionery product.

11. A process according to claim 1 wherein the frozen particles are chocolate-flavoured.

12. A process according to claim 1 wherein the frozen composition is ice cream, water ice, milk ice, sorbet, sherbet or frozen yoghurt.
